(19) United States
(12) Patent Application Publication
(10) Pub. No.: US 2025/0124743 A1
(43) Pub. Date: Apr. 17, 2025

(54) DATA COLLECTION FOR SIGN LANGUAGE RECOGNITION

(71) Applicant: Sorenson IP Holdings, LLC, Salt Lake City, UT (US)

(72) Inventors: David Thomson, Bountiful, UT (US); Conrad Maxwell, Herriman, UT (US)

(21) Appl. No.: 18/913,783

(22) Filed: Oct. 11, 2024

Related U.S. Application Data
(60) Provisional application No. 63/589,552, filed on Oct. 11, 2023.

(51) Int. Cl. G06V 40/20; G10L 15/26

(52) U.S. Cl. CPC G06V 40/28; G10L 15/26

(57) ABSTRACT

A method may include obtaining, at a first device, video data of a video communication session between a first user of the first device and a second user of a second device. The video data may include sign language content. The method may also include procuring multiple sign language objects. Each of the sign language objects may corresponding to a video segment of the video data that includes multiple video frames, and including features of the video segment that conveys one or more word. The method may further include obtaining, at the first device, communication data representing the sign language content in the video data and associating, each of the sign language objects with a different portion of the communication data. The method may further include constructing a sign language recognition model using the sign language objects, the communication data, and the association therebetween.

### CROSS-REFERENCE TO RELATED APPLICATION

This application claims priority to U.S. Provisional Patent Application No. 63/589,552, filed on Oct. 11, 2023, the disclosure of which is incorporated herein by reference in its entirety.

### FIELD

The embodiments discussed herein are related to data collection for sign language recognition.

### BACKGROUND

Traditional communication systems, such as standard and cellular telephone systems, enable verbal communications between people at different locations. Communication systems for hard-of-hearing individuals may also enable non-verbal communications instead of, or in addition to, verbal communications. Some communication systems for hard-of-hearing people enable communications between communication devices for hard-of-hearing people and communication systems for hearing users. For example, a video relay service may provide speech to sign language translation services, and sign language to speech translation services for a communication session between a video phone for a hearing-impaired user and a traditional telephone for a hearing-capable user.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method may include obtaining, at a first device, video data of a video communication session between a first user of the first device and a second user of a second device. The video data may include sign language content. The method may also include procuring multiple sign language objects. Each of the sign language objects may corresponding to a video segment of the video data that includes multiple video frames, and including features of the video segment that conveys one or more word. The method may further include obtaining, at the first device, communication data representing the sign language content in the video data and associating, each of the sign language objects with a different portion of the communication data based on the different portions of the communication data including the one or more words conveyed by the multiple sign language objects. The method may further include constructing a sign language recognition model using the sign language objects, the communication data, and the association therebetween.

### BRIEF DESCRIPTION OF THE DRAWINGS

Example embodiments will be described and explained with additional specificity and detail through the use of the accompanying drawings in which:

FIG. 1 illustrates an example environment for data collection for sign language recognition;

FIG. 2 illustrates data collected for sign language recognition;

FIG. 3 illustrate another example environment for data collection for sign language recognition;

FIG. 4 illustrate a flowchart of another example method to collect data for sign language recognition;

FIG. 5 illustrates a flowchart of another example method to collect data for sign language recognition; and

FIG. 6 illustrates an example system that may be used during data collection for sign language recognition.

### DESCRIPTION OF EMBODIMENTS

Artificial intelligence is being used in numerous fields and industries as it provides various benefits and capabilities that may otherwise not be available. As an example, artificial intelligence may be used to develop systems to assist people to communicate. For example, some people, due to certain health conditions, may communicate via sign language. For those that do not know sign language this presents a barrier for communication. Additionally, communication via a voice call may not be possible without assistance because sign language relies on visual cues instead of verbal communication.

Artificial intelligence may be used to train systems to accurately detect and understand sign languages. The trained systems may be used to translate sign language into a written or spoken language, e.g. sign language interpretation. Alternately or additionally, the trained systems may be used to translate a spoken or written language into sign language, e.g., sign language generation. As such, the trained system may facilitate communication between people that know sign language and those that do not know sign language.

Training systems using artificial intelligence may be done using data that represents use cases that may be encountered by the trained systems. Typically, larger data sets may result in more robust systems as the larger data sets may provide better variability, improved accuracy and/or generalization, more edge cases, and/or better feature representation. Obtaining larger data sets may be difficult in some circumstances due to privacy concerns. For example, systems may exist where datasets may be collected, but the data to be collected may be private and thus may not be collected unless a technical method is used that addresses the privacy concerns.

For example, some systems exist that allow persons with hearing or speech disabilities, who use sign language, to use video equipment to communicate with others via a typical voice telephone service, such as a phone call on a mobile device. As an example, these systems may be referred to as a video relay service (VRS). The communications performed using these systems may be private and thus using the communications to generate datasets for training systems using artificial intelligence may be difficult.

Some embodiments in the present disclosure disclose a system and/or a method to collect data for sign language recognition. For example, in some embodiments, the system and/or the method may be used to collect data from a video relay service. In these and other embodiments, the system and/or the method may be configured to help to address privacy concerns with respect to the data collected.

For example, in some embodiments, a method to collect data may include collecting the data in a manner such that reconstruction of the original content may not be possible. Furthermore, the data may be anonymized such that the origins of the data may not be known. By not allowing reconstruction of the data and anonymizing the origins of the data, the data may be collected and using for training models while avoiding privacy concerns regarding the use of the data.

In some embodiments, a method may include obtaining, at an interpretation device, a video that includes sign language content during a communication between two people. For example, in a VRS context, the video may capture signing of a first person and the interpretation device may be a device of an interpreter that is viewing the video and generating speech that is a translation of the sign language in the video. The speech may be provided to a second person that is communicating with the first person. In these and other embodiments, the interpretation device may analyze the video to procure multiple sign language objects. Additionally, the interpretation device may obtain transcript data of the audio. The transcript data may identity the sign language object. For example, the sign language object may be multiple frames that illustrate one or more movements that represent the word “hello.” In these and other embodiments, the transcript data may include the word “hello.” In these and other embodiments, the sign language object and the transcript data may be associated and provided to a system as training data.

In some embodiments, to help to protect the privacy of the first and second persons, the video and audio may be deleted before the sign language object and the transcript data is directed away from the interpretation device. Alternately or additionally, the sign language object and the transcript data may be encrypted. Alternately or additionally, an order of multiple sign language objects and the transcript data may be scrambled so that the original message may be difficult to reconstruct. Alternately or additionally, sign language objects and the transcript data may be scrambled with sign language objects and the transcript data from other communications. Other procedures may also be used to help to protect the privacy of the first and second persons participating in the communication.

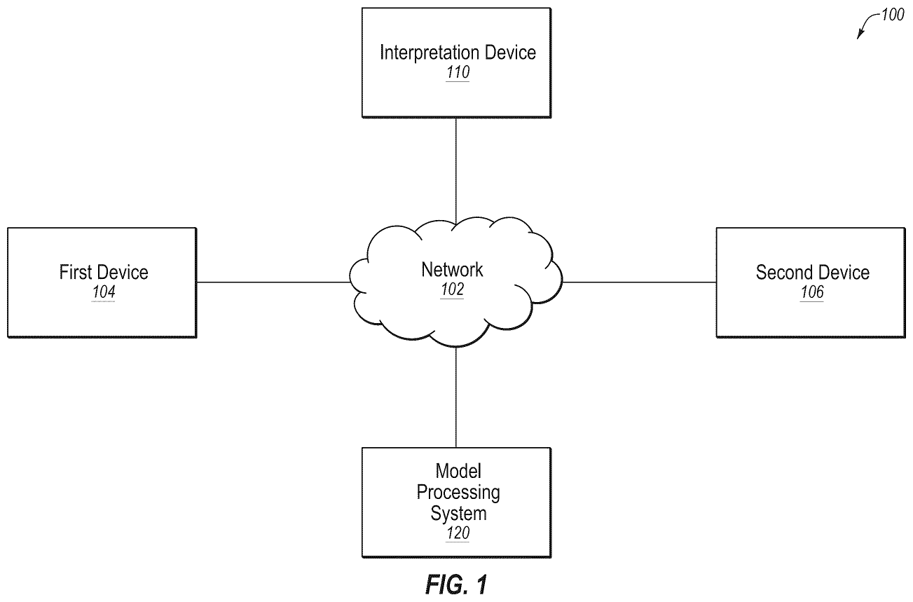

Turning to the figures, FIG. 1 illustrates an example environment 100 for data collection for sign language recognition. The environment 100 may be arranged in accordance with at least one embodiment described in the present disclosure. The environment 100 may include a network 102, a first device 104, a second device 106, an interpretation device 110, and a model processing system 120.

The network 102 may be configured to communicatively couple the first device 104, the second device 106, the interpretation device 110, and the model processing system 120. In some embodiments, the network 102 may be any network or configuration of networks configured to send and receive communications between systems and devices. In some embodiments, the network 102 may include a wired network, an optical network, and/or a wireless network, and may have numerous different configurations, including multiple different types of networks, network connections, and protocols to communicatively couple devices and systems in the environment 100. In some embodiments, the network 102 may also be coupled to or may include portions of a telecommunications network, including telephone lines.

Each of the first device 104, the second device 106, and the interpretation device 110 may include or be any electronic or digital computing device or system. For example, the first device 104 may include a desktop computer, a laptop computer, a smartphone, a mobile phone, a tablet computer, or any other computing device that may be used for video communication. The second device 106 may include a desktop computer, a laptop computer, a smartphone, a mobile phone, a tablet computer, a telephone, a phone console, or any other computing device that may be used for communication. The interpretation device 110 may include a desktop computer, a laptop computer, a smartphone, a tablet computer, or any other computing device and/or system that may be used for video communication.

In some embodiments, each of the first device 104, the second device 106, and the interpretation device 110 may include memory and at least one processor, which are configured to perform operations as described in this disclosure, among other operations. In some embodiments, each of the first device 104, the second device 106, and the interpretation device 110 may include computer-readable instructions that are configured to be executed by each of the first device 104, the second device 106, and the interpretation device 110 to perform operations described in this disclosure.

In some embodiments, each of the first device 104, the second device 106, and the interpretation device 110 may be configured to establish communication sessions with other devices. For example, each of the first device 104, the second device 106, and the interpretation device 110 may be configured to establish an outgoing communication session, such as a telephone call, voice over internet protocol (VOIP) call, video call, or conference call, among other types of outgoing communication sessions, with another device. Alternately or additionally, each of the first device 104, the second device 106, and the interpretation device 110 may be configured to establish an incoming communication session with another device.

In some embodiments, each of the first device 104, the second device 106, and the interpretation device 110 may be configured to obtain audio and/or video during a communication session. As used in this disclosure, the term audio or audio signal may be used generically to refer to sounds that may include spoken words. Furthermore, the term “audio” or “audio signal” may be used generically to include audio in any format, such as a digital format, an analog format, or a propagating wave format. As used in this disclosure, the term video or video data may be used generically to refer to images that may be stored together and when presented in sequence result in a video.

As an example of obtaining audio, the second device 106 may be configured to obtain audio. For example, the second device 106 may obtain the audio from a microphone of the second device 106 or from another device that is communicatively coupled to the second device 106. As an example of obtaining video, the first device 104 may be configured to obtain video. The first device 104 may obtain the video from a camera of the first device 104 or from another device that is communicatively coupled to the first device 104.

In some embodiments, the interpretation device 110 may be configured to be a relay or intermediary device between the first device 104 and the second device 106 during a communication session that includes the first device 104, the second device 106, and the interpretation device 110. For example, the first device 104 may establishing a communication session with the interpretation device 110 and provide communication details with about the second device 106. The interpretation device 110 may establish a communication session with the second device 106. In these and other embodiments, the first device 104 may provide video to the interpretation device 110. In some embodiments, the video may include sign language content. In these and other embodiments, the interpretation device 110 may analyze the video to determine one or more words conveyed by the sign language content. For example, the sign language content may include one or more gestures that may correspond to one or more words. In these and other embodiments, the interpretation device 110 may obtain audio that includes the one or more words corresponding to the sign language content. For example, the interpretation device 110 may present the video to an interpreter associated with the first device 104. In response to presenting the video, the interpretation device 110 may obtain audio from the interpreter.

Alternately or additionally, the interpretation device 110 may use an interpretation model or program to determine one or more words that correspond to the sign language content. In these and other embodiments, the interpretation device 110 may send the words as text or audio that includes a verbalization of the words to the second device 106.

In some embodiments, using an interpretation model or program to determine one or more words that correspond to the sign language content may including providing the video to another system that may include the interpretation model or program. In these and other embodiments, when using an interpretation model or program, a user may verify the audio and/or text generated by the interpretation model or program. In these and other embodiments, in response to an incorrect or less accurate audio and/or text generation, the user may provide some form of correction. The correction may be provided to the second device 106.

In some embodiments, the interpretation device 110 may provide the audio to the second device 106. In these and other embodiments, the audio may correspond to the sign language content in the video provided by the first device 104. Alternately or additionally, the interpretation device 110 may provide text to the second device 106 that includes the one or more words that correspond to the one or more gestures in the sign language content.

In response to obtaining the audio, the second device 106 may present the audio. For example, the second device 106 may present the audio to a user of the second device 106. Alternately or additionally, the second device 106 may obtain audio. The audio may be provided by the user of the second device 106. The second device 106 may provide the audio to the interpretation device 110.

In some embodiments, in response to obtaining audio from the second device 106, the interpretation device 110 may obtain text of the audio. The text of the audio may be provided to the first device 104. For example, text of the audio may be obtained by the interpretation device 110 and/or the interpretation device 110 may provide the audio to a transcription system that may be configured to obtain the text of the audio and provide the text of the audio to the interpretation device 110 and/or the first device 104.

In some embodiments, the transcription system may include any configuration of hardware, such as processors, servers, and database servers that are networked together and configured to perform a task. For example, the transcription system may include one or multiple computing systems, such as multiple servers that each include memory and at least one processor.

In these and other embodiments, the transcription system may be configured to generate a transcription of audio. For example, the transcription system may be configured to generate a transcription of audio using automatic speech recognition (ASR). In some embodiments, the transcription system may use fully machine-based ASR systems that may operate without human intervention. Alternately or additionally, the transcription system may be configured to generate a transcription of audio using a revoicing transcription system. The revoicing transcription system may receive and broadcast audio to a human agent. The human agent may listen to the broadcast and speak the words from the broadcast. The words spoken by the human agent are captured to generate revoiced audio. The revoiced audio may be used by a speech recognition program to generate the transcription of the audio.

Alternately or additionally, in response to obtaining audio from the second device 106, the interpretation device 110 may obtain video. In these and other embodiments, the interpretation device 110 may present the audio from the second device 106. In response to presenting the audio, the interpretation device 110 may obtain video. The video may include sign language content that corresponds to the audio presented by the interpretation device 110. For example, the interpreter associated with the interpretation device 110 may listen to the presented audio and generate sign language content of the audio that is captured by the interpretation device 110 in the video.

An example of the operation of the first device 104, the second device 106, and the interpretation device 110 with respect to communication sessions therebetween is now provided. A first user of the first device 104 may commence to establish a communication session with a second user of the second device 106. The first device 104 may request a communication session with the interpretation device 110 and include information about the second device 106. The interpretation device 110 may establish the communication session with the first device 104 and request a communication session with the second device 106. Thus, the interpretation device 110 may be in a communication session with both the first device 104 and the second device 106. In these and other embodiments, the first user may communicate by signing. The first device 104 may capture video of the signing and provide the video to the interpretation device 110. The interpretation device 110 may display the video to an interpreter. The interpreter may speak words that correspond to the signing. The interpretation device 110 may capture audio that includes the words and direct the words to the second device 106. The second device 106 may broadcast the audio with the words to a second user of the second device 106 to allow communication between the first user and the second user.

In these and other embodiments, the second user may speak words that may be captured in audio by the second device 106. The second device 106 may direct the audio to the interpretation device 110. The interpretation device 110 may obtain text of the words of the audio and/or capture video with sign language gestures that represent the words of the audio. The interpretation device 110 may direct the video and/or text to the first device 104. The first device 104 may display the text and/or video to the first user to allow communication between the first user and the second user.

In some embodiments, the interpretation device 110 may be configured to collect data for sign language recognition. For example, the interpretation device 110 may be configured to collect the data using the video obtained from a first device 104. Alternately or additionally, the interpretation device 110 may be configured to collect the data using the text and/or audio obtained by the interpretation device 110 to direct to the second device 106. As noted, the video, audio, and/or text may include private information. As such, the interpretation device 110 may not be configured to obtain the data in any manner. Rather, the interpretation device 110 may follow one or more technical procedures to help to reduce the risk of invasion of privacy while collecting the data for sign language recognition.

In some embodiments, the interpretation device 110 may collect the data for sign language recognition and provide the data to the model processing system 120. The model processing system 120 may be configured to obtain the data from the interpretation device 110. The model processing system 120 may be configured to construct a sign language recognition model using the data from the interpretation device 110. In these and other embodiments, the model processing system 120 may include any configuration of hardware, such as processors, servers, and database servers that are networked together and configured to perform a task. For example, the model processing system 120 may include one or multiple computing systems, such as multiple servers that each include memory and at least one processor.

In some embodiments, to collect the data for sign language recognition, the interpretation device 110 may obtain the video data from the first device 104. In these and other embodiments, as noted previously, the video data may represent real-time or substantially real-time communications generated by the user of the first device 104 to be communicated to the user of the second device 106.

In response to obtaining the video data from the first device 104, the interpretation device 110 may be configured to analyze the video data to obtain one or more sign language objects associated with the sign language content in the video data. Each of the sign language objects may correspond to one or more words being conveyed by the sign language content.

In these and other embodiments, a sign language object may correspond to a video segment that includes multiple video frames. The multiple video frames, where each frame may be an image, may include one or more features that may convey the one or more words in sign language. In these and other embodiments, the sign language object may include the features that convey the one or more words in sign language.

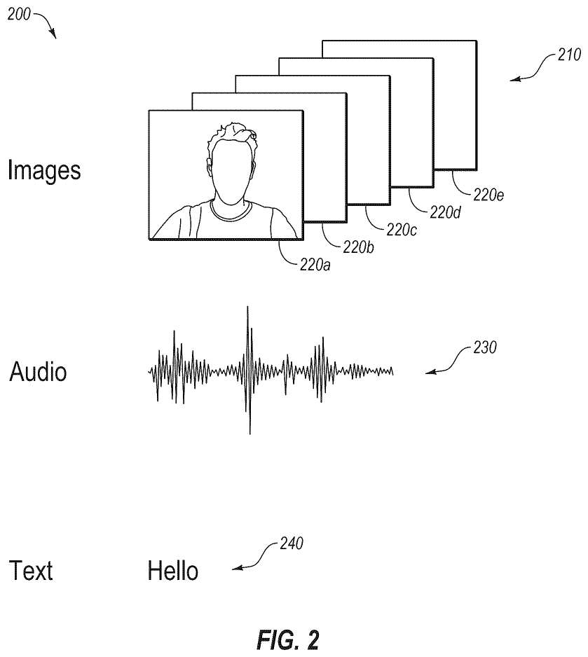

FIG. 2 illustrates data 200 collected for sign language recognition. For example, the data 200 may include a video 210 that includes images 220a-220e, referred to collectively as the images 220. The data 200 may further include audio 230 and text 240.

In these and other embodiments, the images 220 may be an example of frames of a video segment that may correspond to a sign language object. For example, in American Sign Language (ASL), the gesture for “hello” is typically done by extending your fingers and crossing your thumb in front of your palm. The hand is brought in front of your ear and extended outward and away from your body. In addition to the movement of the hand, the user may maintain a friendly and relaxed facial expression while making the gesture.

Note that the gesture for “hello” may take up to two seconds. The video may have a rate of thirty frames per second. As such, the gesture for “hello” may include sixty frames or images to capture. Alternately or additionally, the facial expression may be important for correct interpretation of the sign in addition to the configuration of the hand and the movement of the hand and arm. Thus, the sign language object may be more than a single image but may include multiple different aspects. For example, the sign language object may include data to indicate the configuration of body parts, the movement of body parts, and body language expressions, such as facial expressions. The sign language objects may include images, vectors, arrays, or other data objects that may include the information associated with the sign language content in the video data.

Returning to FIG. 1, in some embodiments, the interpretation device 110 may be further configured to obtain audio that corresponds to the sign language content in the video data. For example, the audio may be generated by a model or program or an interpreter that is associated with the interpretation device 110. In these and other embodiments, the interpretation device 110 may obtain text of the audio. The text may be obtained from a transcription system on the interpretation device 110 or that is networked with the interpretation device 110.

The interpretation device 110 may be configured to associate portions of the text with a corresponding sign language object. For example, a sign language object may include the features associated with the word “hello.” In these and other embodiments, the interpretation device 110 may associate a portion of the text that includes the word “hello” with the sign language object. As an example, the interpretation device 110 may analyze the text received into phrases that include one or more words. The phrases may be further processed to remove words that are not represented in sign language, such as prepositions, transition words, introductory words, verbs, etc. Using a time stamp, ordering, or some other identifier, the interpretation device 110 may associate a phrase from the text with a sign language object. For example, a sign language object may be generated from a video segment that is presented from time T1 to time T2. Audio may be obtained from time T1+delta1 to time T2+delta2. The text associated with the audio obtained from time T1+delta1 to time T2+delta2 may be associated with the sign language object. The text associated with the sign language object may include one or more words that may be conveyed by the sign language object.

For example, FIG. 2 illustrates the video 210 that includes the images 220. The images may convey the word “hello.” The audio 230 may include the word “hello” in audible form and the text 240 may include the word “hello” in textual form. The text 240 may be associated with a sign language object that is generated from the images 220 as the text 240 may include the word conveyed by the images 220.

Returning to the discussion of FIG. 1, in some embodiments, a sign language object and the associated text may be referred to as a training object. After obtaining the training object, the interpretation device 110 may deleted the original video and/or audio associated with the training object. After deleting the original video and/or audio, the interpretation device 110 may direct the training object to the model processing system 120. As such, the original video and/or audio may not be stored on the interpretation device 110 after the training object has left the interpretation device 110. As a result, it may not be possible for the original video and/or audio of the training object to be obtained via accessing the interpretation device 110.

In some embodiments, the training objects may be encrypted before being directed to the model processing system 120 by the interpretation device 110. In these and other embodiments, any type of encryption method may be used. Alternately or additionally, the interpretation device 110 may not include a decryption key. Rather, the interpretation device 110 may only include the encryption key. Thus, if the security of the interpretation device 110 is compromised, a decryption key may not be accessed.

In some embodiments, the interpretation device 110 may be configured to cull one or more of the sign language objects. For example, the interpretation device 110 may obtain the sign language objects and the associated text. The interpretation device 110 may analyze the associated text before associating the text and the sign language object. Based on the analysis of the text, the interpretation device 110 may remove the signal language object and not generate a training object to direct to the model processing system 120. The analysis of the text may be concerned with the information included in the text. For example, the analysis may be performed to detect particular types of information. In response to the text including a type of information indicated to be culled, the interpretation device 110 may remove the sign language object and the text. As an example, the type of information that result in the remove of the sign language object may include information subject to privacy rules and/or regulations. For example, identifying numbers, financial information, personal information, or any other type of private information may be culled.

In these and other embodiments, the interpretation device 110 may be further configured to remove other information that may be included as part of the training object, such as information regarding a location and/or time of creation, among other types of information.

In some embodiments, the interpretation device 110 may generate a training object and delete the original video and audio associated with training object and direct the training object to the model processing system 120 while generating other training objects. As such, the interpretation device 110 may send the training objects once completed. Alternately or additionally, the interpretation device 110 may batch the training objects. In these and other embodiments, the interpretation device 110 may send the training objects in groups of two or more. In these and other embodiments, the interpretation device 110 may delete the original video and audio for all the training objects before sending the batch of training objects. Alternately or additionally, the interpretation device 110 may send all the training objects for a communication session after termination of the communication session. In these and other embodiments, the interpretation device 110 may send a single batch of training object.

In some embodiments, the interpretation device 110 may randomly or pseudo-randomly order the training objects in the batch of training objects for directing to the model processing system 120. As such, the order in which the model processing system 120 may obtain the training objects may not represent the communication occurring between the user of the first device 104 and the user of the second device 106. Randomly ordering the training objects may assist in preserving privacy of the users.

Alternately or additionally, the interpretation device 110 may combine training objects from multiple communications. For example, first training objects may be generated based on a first communication and second training objects may be generated based on a second communication. In these and other embodiments, the first training objects and the second training objects may be combined into a batch of training objects before being directed to the model processing system 120. In these and other embodiments, the training objects may be combined randomly, pseudo-randomly, or using some other method of combination.

Alternately or additionally, multiple batches of training objects may be obtained from multiple different sets of training objects that result from multiple communications. For example, two batches of training objects may be obtained from two sets of training objects that result from two communications, respectively. In these and other embodiments, the batches of training objects may be obtained by randomly selecting the training objects from the sets of training objects for the different batches of training objects.

In some embodiments, the interpretation device 110 may begin generation of the training objects in real-time during a communication session between the first device 104 and the second device 106. In these and other embodiments, the interpretation device 110 may thus be generating the training objects in real-time as the video is presented by the interpretation device 110 and the audio generated and provided to the second device 106. For example, during a communication session, the interpretation device 110 may obtain video. In response to obtaining the video and in real-time with reception of the video, the interpretation device 110 may begin the training object generation process as described in this disclosure. In these and other embodiments, the interpretation device 110 may not generate training objects during the entire length of the communication session. For example, when the user of the second device 106 is speaking and the video does not include sign language content, the interpretation device 110 may not generate the training objects.

In some embodiments, the interpretation device 110 may conclude generation of the training objects at the termination of the communication session and/or shortly after termination of the communication session based on the processing power of the interpretation device 110. For example, the interpretation device 110 may work consistently during and after the communication session until the training objects are generated and directed to the model processing system 120. As such, the video and/or audio of the communication session may not be stored on the interpretation device 110 expect for during the communication session and shortly after the communication session until processing of the training objects from the communication session are completed. As an example, the short time period may be 15, 30, or 45 seconds or 1, 2, 3, 4, or 5 minutes.

In some embodiments, the interpretation device 110 may generate training objects for each of the communication sessions that the interpretation device 110 handles. As such, the interpretation device 110 may provide the training objects to the model processing system 120 during and/or shortly after the communication session. In these and other embodiments, the interpretation device 110 may be configured to handle a single communication session at a time. As a result, the interpretation device 110 may generate training objects in a sequential manner based on the videos received from the communication sessions. Alternately or additionally, the interpretation device 110 may only generate training objects for some of the communication session handled by the interpretation device 110. For example, the interpretation device 110 may only generate training objects based on the type of the call. For example, a call subject to a privilege, such as with a doctor, lawyer, or other medical professional, or financial professional, may not be used to generate training objects. Alternately or additionally, a user may determine which communication sessions may be used to generate training objects. For example, the interpretation device 110 may use preferences or feedback for each individual communication session to determine which communication sessions may be used to generate training objects.

In some embodiments, the model processing system 120 may be configured to use a machine learning algorithm to generate a model using the training objects. For example, a portion of the training objects may be used to train the model using the machine learning algorithm. The model may be provided the sign language objects and the corresponding text. The model may be trained to recognize the sign language objects based on the corresponding text. The machine learning algorithm may be a convolutional neural network, a recurrent neural network, a hidden Markov model, a support vector machine, ensembles methods, and/or combination thereof, including other types of machine learning models. The generated model may be provided images or sign language objects and select text to which the images or sign language object may correspond.

In some embodiments, the training objects may be deleted from the model processing system 120 after a model is trained using the training objects. In these and other embodiments, the model processing system 120 may be trained in response to obtaining the training objects. As a result, the training objects may not be stored on the model processing system 120 for a period of time longer than for training a model using the training objects.

Modifications, additions, or omissions may be made to the environment 100 without departing from the scope of the present disclosure. For example, in some embodiments, the environment 100 may include additional devices. For example, another device may participate in the communication session and the interpretation device 110 may provide the audio to the other device as well as the second device 106.

As another example, the user of the second device 106 may also use sign language. In these and other embodiments, the interpretation device 110 may obtain video from each of the first device 104 and the second device 106. The interpretation device 110 may generate training objects for only a part or all the video that the interpretation device 110 obtains. As another example, the training objects may include the audio that corresponds with the sign language object instead of or in addition to the text.

As another example, the model processing system 120 may not obtain the training objects. In these and other embodiments, each of the interpretation devices 110 may include a model that may be trained using the training objects that are generated by the interpretation devices 110. For example, an interpretation device 110 may be configured to generate training objects as discussed in this disclosure. The interpretation device 110 may further include an algorithm that may train a model. In these and other embodiments, training the model may include selecting one or more parameters for the model. The interpretation device 110 may use the generated training objects to train the model on the interpretation device 110. After training the model using the training objects, the training objects may be deleted. In these and other embodiments, the training of the model using the training objects may occur as the training objects are generated. As a result, the training of the model using a first training object may occur during a communication that results in the generation of the first training object. For example, based on a communication audio and video may be obtained. During the communication, a first training object may be generated. After generation of the first training object and during the communication, the model may be trained during the first training object. After training of the model and during the communication, the first training object may be deleted. As such, a model may be trained, and one or more training objects deleted before a communication is terminated. In these and other embodiments, training objects generated near an end of a communication may be used to train a model and deleted after termination of the communication, but the training objects may only be maintained for a time sufficient to complete training of the model.

In these and other embodiments, the interpretation devices 110 may send generated parameters and/or models to the model processing system 120. The model processing system 120 may use the generated parameters and/or models from the interpretation devices 110 to generate a comprehensive model that may be used by other devices. In these and other embodiments, the algorithm used to generate the model may be conducive to segmenting training of parameters and/or model as described in this disclosure.

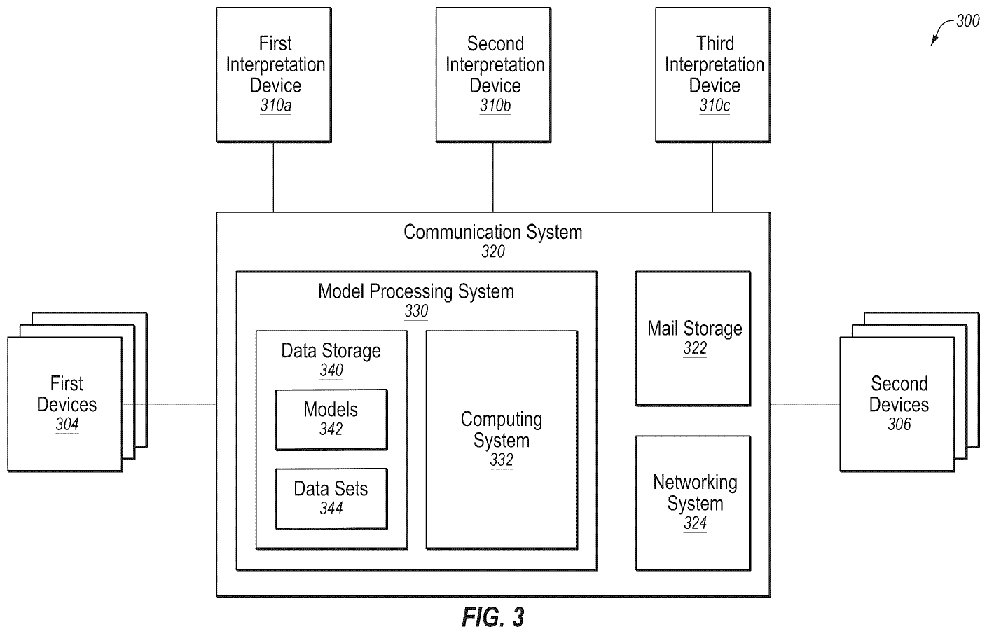

FIG. 3 illustrate another example environment 300 for data collection for sign language recognition. The environment 300 may include first devices 304, second devices 306, a first interpretation device 310a, a second interpretation device 310b, and a third interpretation device 310c, referred to collectively as the interpretation devices 310. The environment 300 may further include a communication system 320. The communication system 320 may include a mail storage 322, a network system 324, and a model processing system 330. The model processing system 330 may include a computing system 332 and a data storage 340. The data storage may include models 342 and data sets 344.

In some embodiments, the first devices 304, the second devices 306, and the interpretation devices 310 may be analogous to the first device 104, the second device 106, and the interpretation device 110, respectively, of FIG. 1. Thus, no further description may be provided here expect where differences may exist. Furthermore, one or more networks, such as the network 102 may communicatively couple the one or more of the first devices 304, the second devices 306, the interpretation devices 310, and the communication system 320.

In some embodiments, the communication system 320 may be configured to assist in connecting one of the first devices 304 and one of the second devices 306 in a communication session with one of the interpretation devices 310. In these and other embodiments, the network system 324 of the communication system 320 may include one or more devices, systems, and/or protocols to assist in establishing communication between the first devices 304, the second devices 306, and the interpretation devices 310 to allow for the flow of information as described with respect to FIG. 1.

In some embodiments, during and/or after communication sessions, each of the interpretation devices 310 may provide the training objects resulting from the communication sessions to the communication system 320. In these and other embodiments, the communication system 320 may store the training objects in the data storage 340 as the data sets 344. In these and other embodiments, the communication system 320 may not obtain the video and/or the audio from the communication sessions. In these and other embodiments, only the interpretation devices 310 may obtain the video and/or audio of the communication sessions. Furthermore, the video and/or audio of a communication session may not be shared between the interpretation devices 310. For example, a communication session involving the first interpretation device 310a may include first video and first audio that may not be shared or known to the second interpretation device 310b, the third interpretation device 310c, and the communication system 320. In these and other embodiments, only the communication system 320 may receive the data objects.

In some embodiments, the mail storage 322 of the communication system 320 may be configured to store videos that include sign language content. For example, the videos that may be stored may be those videos for which a user has granted the communication system 320 permission to store. As an example, the stored videos may be videos of notifications for registered users of the communication system 320. For example, one of the second devices 306 may attempt to communicate with one of the first devices 304. The one of the first devices 304 may not establish a communication session, e.g., a user of the one of the first devices 304 may not be available. As such, a message may be left. The message may be converted to sign language and a video may be stored that captures the sign language. The stored video may be stored in the mail storage 322. In these and other embodiments, training objects may be extracted from the videos in the mail storage 322 in a similar manner as training objects are extracted from live video during communication sessions. The training objects may be stored as data sets 344 in the data storage 340. In some embodiments, the videos in the mail storage 322 may be stored with homomorphic encryption such that the training objects may be extracted from the videos without decrypting the videos.

In some embodiments, the data sets 344 may be further refined or additional information may be provided to the data sets 344 before and/or after the data sets 344 are used to generate the models 342. For example, a user may review the training data and add additional information or syntax to the text or make corrections to the text.

In some embodiments, the model processing system 330 may be configured to generate the models 342 using the data sets 344. For example, a machine learning algorithm, natural language processing algorithm, or a computer vision algorithm and/or combinations thereof may be used by the system 332 to generate the models 342 using the data sets 344. For example, a convolutional neural network or recurrent neural network may be used. To begin, the data sets 344 may be processed to normalize the data sets 344. After processing, the models 342 may be trained such that the models 342 are able to map sign language content from images to the text associated with the sign language content from the data sets 344.

After training the models may be used to recognize sign language content. For example, one or more of the interpretation devices 310 may be deployed with the models. In these and other embodiments, the interpretation devices 310 may obtain video from the first devices 304 and generate text that corresponds to the sign language content in the videos. The text or audio generated from the text may be provided to the second devices 306.

Modifications, additions, or omissions may be made to the environment 300 without departing from the scope of the present disclosure. For example, in some embodiments, the environment 300 may include additional devices. In these and other embodiments, the environment may include additional interpretation devices 310. Alternately or additionally, the components of the communication system 320 may be distributed in multiple different systems that are network connected.

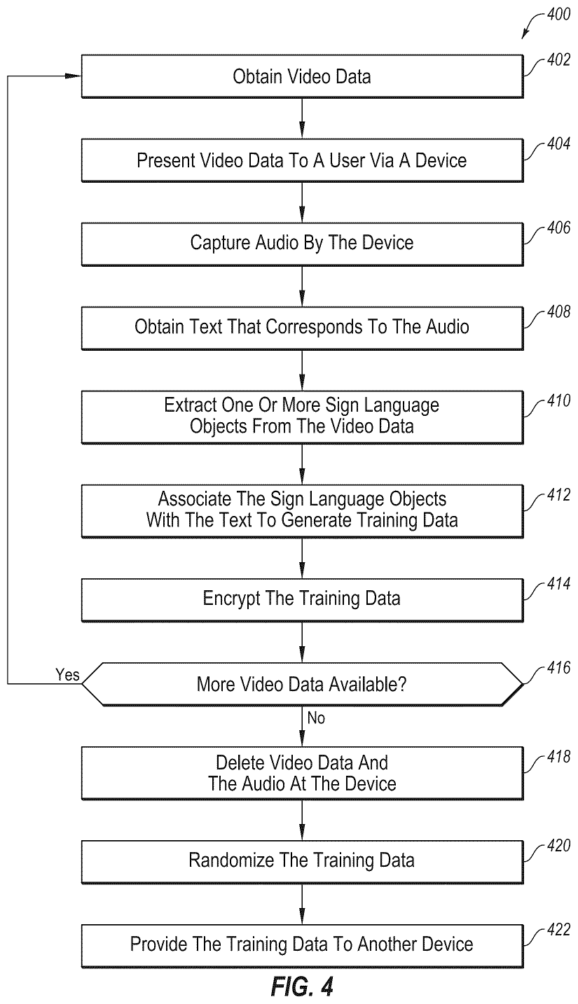

FIG. 4 illustrates a flowchart of an example method 400 to collect data for sign language recognition. The method 400 may be arranged in accordance with at least one embodiment described in the present disclosure. One or more operations of the method 400 may be performed, in some embodiments, by a device or system, such as the interpretation device 110 of FIG. 1 or another device or combination of devices. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 402, where video data may be obtained. The video data may be obtained from a communication session. For example, the communication session may be a real-time communication session between two or more devices. In the communication session, a user of each of the devices may be communicating. In these and other embodiments, the video data may be obtained in real-time from a video stream obtained at one of the devices, such as an interpretation device. The video data may include sign language content. For example, one of the users may sign and video of the user may be captured at a first device and streamed during the communication session to a second device.

At block 404, the video data may be presented to a user. For example, the video data may be video data that is obtained by a device during a communication session. The video data may be presented on a display of a device to a user. For example, the user may be an interpreter that is associated with the interpretation device.

At block 406, audio may be capture by the device. The audio may be words spoken by the interpreter that correspond to the sign language content in the video data. For example, the interpreter may interpret the sign language content in the video data being presented on the display of the interpretation device. The interpreter may speak the words that correspond to the sign language content. The words may be audio that are captured by a microphone of the interpretation device.

At block 408, text may be obtained that corresponds to the audio. For example, the audio may be provided to an ASR system that may generate the text. As an example, the ASR system may be run by the interpretation device. Alternately or additionally, the ASR system may be separate from the interpretation device. In these and other embodiments, the interpretation device may direct the audio to the ASR system. The ASR system may generate text data that corresponds to the words spoken in the audio. The ASR system may provide the text data to the interpretation device as the text.

At block 410, one or more sign language objects may be extracted from the video data. The sign language objects may represent sign language content, such as one or more words of sign language, from the video data. The sign language content represented by a sign language object may extend across multiple frames of the video data. In some embodiments, a device participating in the communication session may extract the sign language objects. Alternately or additionally, another device or system may extract the sign language objects. In these and other embodiments, the sign language objects may include one or more image or frames of the video data. For example, the sign language object may be a single image that includes a particular hand position that represents a word in sign language. Alternately or additionally, the sign language object may be multiple frames, e.g., multiple images, which form a short video, that forms the sign language object. For example, the sign language object may represent a sign that includes a particular hand position and movement of the hand.

At block 412, the sign language object may be associated with the text generated in block 408, which represents the sign language content in the sign language object, to generate training data. For example, the sign language object may be associated with the text generated in block 408 by connecting the text with the sign language object via a pointer or some other way to associate data stored in a data storage.

At block 414, the training data may be encrypted. The encryption may be performed using any method of encryption. At block 416, it may be determined if further video data is available of the communication session. In response to further video data being available, the method 400 may proceed to block 402. In response to no further video data being available, the method 400 may proceed to block 418.

At block 418, the video data and the audio at the device may be deleted. At block 420, the device may randomize the training data such that an order of the training data may be different when provided to another device than when the training data was generated. In these and other embodiments, at block 420, the training data may be randomized by combining the training data with other training data from another communication session. For example, the training data from a previous communication session may be randomized with the training data of the communication session.

At block 422, the training data may be provided to another device or system. The training device may be used by the other device or system to train a model for recognizing sign language content. The model may be trained using any type of machine learning or AI training techniques.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 400 may not include the block 422. In these and other embodiments, the method 400 may include training a model using the training data. In these and other embodiments, after training the model, the training data may be deleted. Alternately or additionally, the model may be provided to another device. The other device may combine the model with one or more other models to obtain a secondary model that may be used to interpret or generate sign language.

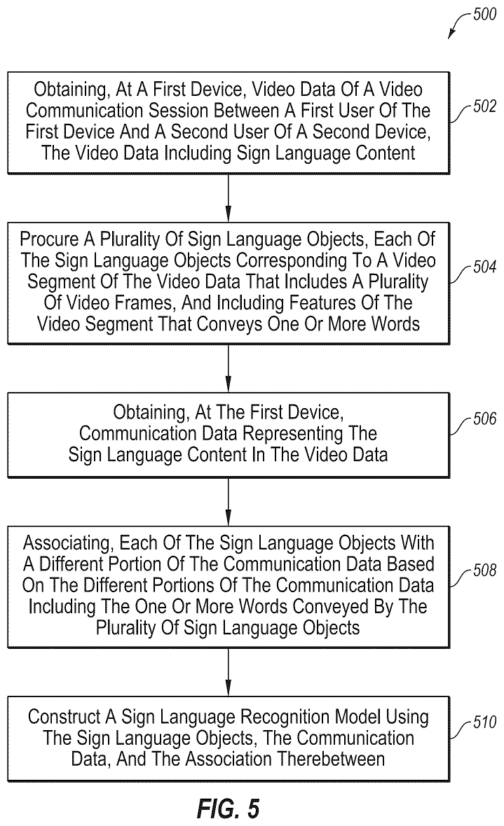

FIG. 5 illustrates a flowchart of an example method 500 to collect data for sign language recognition. The method 500 may be arranged in accordance with at least one embodiment described in the present disclosure. One or more operations of the method 500 may be performed, in some embodiments, by a device or system, such as the interpretation device 110 of FIG. 1 or another device or combination of devices. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where video data of a video communication session between a first user of the first device and a second user of a second device may be obtained at a first device. In these and other embodiments, the video data including sign language content.

At block 504, multiple sign language objects may be obtained. In these and other embodiments, each of the sign language objects may corresponding to a video segment of the video data that includes multiple video frames and that includes features of the video segment that conveys one or more word.

At block 506, communication data representing the sign language content in the video data may be obtained at the first device.

At block 508, each of the sign language objects may be associated with a different portion of the communication data based on the different portions of the communication data including the one or more words conveyed by the plurality of sign language objects.

At block 510, a sign language recognition model may be constructed using the sign language objects, the communication data, and the association therebetween.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 500 may further include directing the multiple sign language objects, the communication data, and the associations therebetween to a system configured to construct a sign language recognition model using the sign language objects, the communication data, and the association therebetween. In these and other embodiments, the system may construct the sign language recognition model.

Alternately or additionally, the method 500 may further include before directing the multiple sign language objects, the communication data, and the associations therebetween to the system, deleting the video data and the communication data. Alternately or additionally, the method 500 may further include encrypting the multiple sign language objects and the communication data before directing the plurality of sign language objects, the communication data, and the associations therebetween to the system. As another example, the method 500 may also include removing one or more of the multiple sign language objects before directing the multiple sign language objects to the system based on a type of information conveyed by the one or more multiple sign language objects.

In some embodiments, in the method 500 an order in which the multiple sign language objects are directed to the system is randomized such that the system is unaware of the order of the plurality of sign language objects as contained in the video data.

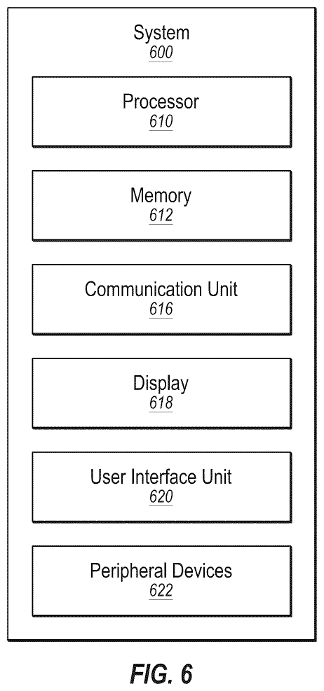

FIG. 6 illustrates an example system 600 that may be used during transcription presentation. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure.

For example, the system 600 may be part of the interpretation device 110 of FIG. 1 and may be configured to perform one or more of the tasks described above with respect to the interpretation device 110.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to transcription presentation such that the system 600 may perform or direct the performance of the operations associated therewith as directed by the instructions. In these and other embodiments, the instructions may be used to perform one or more operations of the method 400 or the method 500 of FIGS. 4 and 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present video, text captions, user interfaces, and other data as directed by the processor 610.

The user interface unit 620 may include any device to allow a user to interface with the system 600. For example, the user interface unit 620 may include a mouse, a track pad, a keyboard, buttons, camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices. In these and other embodiments, the microphone may be configured to capture audio. The imager may be configured to capture images. The images may be captured in a manner to produce video or image data. In some embodiments, the speaker may broadcast audio received by the system 600 or otherwise generated by the system 600.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

The subject technology of the present disclosure is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example. The following is a non-limiting summary of some example implementations presented herein.

Example 1 includes a method including: obtaining, at a first device, video data of a video communication session between a second device and the first device, the video data including sign language content; analyzing the video data to procure a plurality of sign language objects, each of the sign language objects corresponding to a video segment of the video data that includes a plurality of video frames and including features of the video segment that conveys one or more words; capturing audio that includes spoken words that represents the sign language content in the video data; obtaining transcript data that includes a transcription of the spoken words in the audio; associating, each of the sign language objects with a different portion of the transcript data based on the different portions of the transcript data including the one or more words conveyed by the plurality of sign language objects; and directing the plurality of sign language objects, the transcript data, and the associations therebetween to a system configured to construct a sign language recognition model using the sign language objects, the transcript data, and the association therebetween.

Example 2 includes example 1 and further comprises before directing the plurality of sign language objects, the transcript data, and the associations therebetween to the system, deleting the video data and the audio from the first device.

Example 3 includes one or more of the examples 1 and 2, wherein an order in which the plurality of sign language objects are directed to the system is randomized such that the system is unaware of the order of the plurality of sign language objects as contained in the video data.

Example 4 includes one or more of examples 1-3 and further comprises combining the plurality of sign language objects with a plurality of second sign language objects generated using a second communication session, wherein the combined the plurality of sign language objects with a plurality of second sign language objects are directed to the system.

Example 5 includes one or more of the examples 1-4 and further comprises removing one or more of the plurality of sign language objects before directing the plurality of sign language objects to the system based on a type of information conveyed by the one or more plurality of sign language objects.

Example 6 includes one or more of the examples 1-5 and further comprises directing, from the first device, the audio and/or the transcript data to a third device during the video communication session between the first device and the second device.

Example 7 includes one or more of the examples 1-6 and further comprises obtaining, at the system, the plurality of sign language objects, the transcript data, and the associations therebetween from the first device and obtaining a plurality of second pluralities of sign language objects, a plurality of transcript data, and associations therebetween from a plurality of devices that do not include the first device; and constructing a sign language recognition model using the plurality of sign language objects, the transcript data, and the associations and the plurality of second pluralities of sign language objects, the plurality of transcript data, and the associations therebetween.

Example 8 includes one or more of the examples 1-7, wherein each of the plurality of second pluralities of sign language objects are generated from a video communication session between different set of devices.

Example 9 includes one or more computer readable media configured to store instructions, which when executed, are configured to cause performance of the method of any of the proceeding examples.

Example 10 includes a method comprising: obtaining, at a first device, video data of a video communication session between a first user of the first device and a second user of a second device, the video data including sign language content; procuring a plurality of sign language objects, each of the sign language objects corresponding to a video segment of the video data that includes a plurality of video frames, and including features of the video segment that conveys one or more words; obtaining, at the first device, communication data representing the sign language content in the video data; associating, each of the sign language objects with a different portion of the communication data based on the different portions of the communication data including the one or more words conveyed by the plurality of sign language objects; and constructing a sign language recognition model using the sign language objects, the communication data, and the association therebetween.

Example 11 includes one or more of the example 10 and further comprises directing the plurality of sign language objects, the communication data, and the associations therebetween to a system configured to construct a sign language recognition model using the sign language objects, the communication data, and the association therebetween, wherein the system constructs the sign language recognition model.

Example 12 includes one or more of the examples 10 and 11 and further comprises before directing the plurality of sign language objects, the communication data, and the associations therebetween to the system, deleting the video data and the communication data.

Example 13 includes one or more of the examples 10-12, wherein an order in which the plurality of sign language objects are directed to the system is randomized such that the system is unaware of the order of the plurality of sign language objects as contained in the video data.

Example 14 includes one or more of the examples 10-13 and further comprises encrypting the plurality of sign language objects and the communication data before directing the plurality of sign language objects, the communication data, and the associations therebetween to the system.

Example 15 includes one or more of the examples 10-14 and further comprises removing one or more of the plurality of sign language objects before directing the plurality of sign language objects to the system based on a type of information conveyed by the one or more plurality of sign language objects.

Example 16 includes one or more of the examples 10-15 and further comprises: obtaining the plurality of sign language objects, the communication data, and the associations therebetween; and obtaining a plurality of second pluralities of sign language objects, a plurality of communication data, and associations therebetween, wherein the sign language recognition model is constructed using the plurality of sign language objects, the communication data, and the associations and the plurality of second pluralities of sign language objects, the plurality of communication data, and the associations therebetween.

Example 17 includes one or more of the examples 10-16, wherein each of the plurality of second pluralities of sign language objects are generated from a video communication session between different set of devices.

Example 18 includes a method comprising: obtaining a plurality of videos, each of the videos including sign language content; for each of the videos, performing the following: analyzing the video to procure a plurality of sign language objects, each of the sign language objects corresponding to a video segment of the video that includes a plurality of video frames and including features of the video segment that conveys one or more words; capturing audio that includes spoken words that represents the sign language content in the video; obtaining transcript data that includes a transcription of the spoken words in the audio; associating, each of the sign language objects with a different portion of the transcript data based on the different portions of the transcript data including the one or more words conveyed by the plurality of sign language objects; deleting the video and the audio; and after deleting the video and the audio, directing the plurality of sign language objects, the transcript data, and the associations therebetween to a system configured to construct a sign language recognition model using the sign language objects, the transcript data, and the association therebetween, wherein the plurality of videos are obtained sequentially such that one video is not obtained until after a previous video is deleted.

Example 19 includes example 18, wherein an order in which the plurality of sign language objects are directed to the system is randomized such that the system is unaware of the order of the plurality of sign language objects as contained in the video.

Example 20 includes one or more of the examples 18 and 19 and further comprises removing one or more of the plurality of sign language objects before directing the plurality of sign language objects to the system based on a type of information conveyed by the one or more plurality of sign language objects.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method comprising:
obtaining, at a first device, video data of a video communication session between a second device and the first device, the video data including sign language content;
analyzing the video data to procure a plurality of sign language objects, each of the sign language objects corresponding to a video segment of the video data that includes a plurality of video frames and including features of the video segment that conveys one or more words;
capturing audio that includes spoken words that represents the sign language content in the video data;
obtaining transcript data that includes a transcription of the spoken words in the audio;
associating, each of the sign language objects with a different portion of the transcript data based on the different portions of the transcript data including the one or more words conveyed by the plurality of sign language objects; and
directing the plurality of sign language objects, the transcript data, and the associations therebetween to a system configured to construct a sign language recognition model using the sign language objects, the transcript data, and the association therebetween.

2. The method of claim 1, further comprising, before directing the plurality of sign language objects, the transcript data, and the associations therebetween to the system, deleting the video data and the audio from the first device.

3. The method of claim 1, wherein an order in which the plurality of sign language objects are directed to the system is randomized such that the system is unaware of the order of the plurality of sign language objects as contained in the video data.

4. The method of claim 1, further comprising combining the plurality of sign language objects with a plurality of second sign language objects generated using a second communication session, wherein the combined the plurality of sign language objects with a plurality of second sign language objects are directed to the system.

5. The method of claim 1, further comprising removing one or more of the plurality of sign language objects before directing the plurality of sign language objects to the system based on a type of information conveyed by the one or more plurality of sign language objects.

6. The method of claim 1, further comprising directing, from the first device, the audio and/or the transcript data to a third device during the video communication session between the first device and the second device.

7. The method of claim 1, further comprising
obtaining, at the system, the plurality of sign language objects, the transcript data, and the associations therebetween from the first device and obtaining a plurality of second pluralities of sign language objects, a plurality of transcript data, and associations therebetween from a plurality of devices that do not include the first device; and
constructing a sign language recognition model using the plurality of sign language objects, the transcript data, and the associations and the plurality of second pluralities of sign language objects, the plurality of transcript data, and the associations therebetween.

8. The method of claim 7, wherein each of the plurality of second pluralities of sign language objects are generated from a video communication session between different set of devices.

9. One or more computer readable media configured to store instructions, which when executed, are configured to cause performance of the method of claim 1.

10. A method comprising:
obtaining, at a first device, video data of a video communication session between a first user of the first device and a second user of a second device, the video data including sign language content;
procuring a plurality of sign language objects, each of the sign language objects corresponding to a video segment of the video data that includes a plurality of video frames, and including features of the video segment that conveys one or more words;
obtaining, at the first device, communication data representing the sign language content in the video data;
associating, each of the sign language objects with a different portion of the communication data based on the different portions of the communication data including the one or more words conveyed by the plurality of sign language objects; and
constructing a sign language recognition model using the sign language objects, the communication data, and the association therebetween.

11. The method of claim 10, further comprising directing the plurality of sign language objects, the communication data, and the associations therebetween to a system configured to construct a sign language recognition model using the sign language objects, the communication data, and the association therebetween, wherein the system constructs the sign language recognition model.

12. The method of claim 11, further comprising before directing the plurality of sign language objects, the communication data, and the associations therebetween to the system, deleting the video data and the communication data.

13. The method of claim 11, wherein an order in which the plurality of sign language objects are directed to the system is randomized such that the system is unaware of the order of the plurality of sign language objects as contained in the video data.

14. The method of claim 11, further comprising encrypting the plurality of sign language objects and the communication data before directing the plurality of sign language objects, the communication data, and the associations therebetween to the system.

15. The method of claim 11, further comprising removing one or more of the plurality of sign language objects before directing the plurality of sign language objects to the system based on a type of information conveyed by the one or more plurality of sign language objects.

16. The method of claim 10, further comprising:
obtaining the plurality of sign language objects, the communication data, and the associations therebetween; and
obtaining a plurality of second pluralities of sign language objects, a plurality of communication data, and associations therebetween, wherein the sign language recognition model is constructed using the plurality of sign language objects, the communication data, and the associations and the plurality of second pluralities of sign language objects, the plurality of communication data, and the associations therebetween.

17. The method of claim 16, wherein each of the plurality of second pluralities of sign language objects are generated from a video communication session between different set of devices.

18. A method comprising:
obtaining a plurality of videos, each of the videos including sign language content;
for each of the videos, performing the following:
analyzing the video to procure a plurality of sign language objects, each of the sign language objects corresponding to a video segment of the video that includes a plurality of video frames and including features of the video segment that conveys one or more words;
capturing audio that includes spoken words that represents the sign language content in the video;
obtaining transcript data that includes a transcription of the spoken words in the audio;
associating, each of the sign language objects with a different portion of the transcript data based on the different portions of the transcript data including the one or more words conveyed by the plurality of sign language objects;
deleting the video and the audio; and
after deleting the video and the audio, directing the plurality of sign language objects, the transcript data, and the associations therebetween to a system configured to construct a sign language recognition model using the sign language objects, the transcript data, and the association therebetween,
wherein the plurality of videos are obtained sequentially such that one video is not obtained until after a previous video is deleted.

19. The method of claim 18, wherein an order in which the plurality of sign language objects are directed to the system is randomized such that the system is unaware of the order of the plurality of sign language objects as contained in the video.

20. The method of claim 18, further comprising removing one or more of the plurality of sign language objects before directing the plurality of sign language objects to the system based on a type of information conveyed by the one or more plurality of sign language objects.
